(19) United States
(12) Patent Application Publication
(10) Pub. No.: US 2026/0189125 A1
(43) Pub. Date: Jul. 2, 2026

(54) TECHNIQUES FOR SAFE STARTUP, BOOTSTRAP GENERATION AND HIGH-EFFICIENCY LIGHT-LOAD OPERATION IN VOLTAGE CONVERTERS

(71) Applicants: Nachiket Desai, Portland, OR (US); Mausamjeet Khatua, Hillsboro, OR (US); Suhwan Kim, Portland, OR (US); Harish K. Krishnamurthy, Beaverton, OR (US); Jingshu Yu, Hillsboro, OR (US)

(72) Inventors: Nachiket Desai, Portland, OR (US); Mausamjeet Khatua, Hillsboro, OR (US); Suhwan Kim, Portland, OR (US); Harish K. Krishnamurthy, Beaverton, OR (US); Jingshu Yu, Hillsboro, OR (US)

(21) Appl. No.: 19/003,690

(22) Filed: Dec. 27, 2024

(51) Int. Cl. H02M 1/00; H02M 1/14; H02M 3/155

(52) U.S. Cl. CPC H02M 1/0032; H02M 1/14; H02M 3/155

(57) ABSTRACT

Some embodiments include an apparatus including a first flying capacitor coupled to a first node shared by a first P-type transistor and a first N-type transistor and to a second node shared by a second P-type transistor and a second N-type transistor; a second flying capacitor coupled to the first N-type transistor and to a third node shared by a third P-type transistor and a third N-type transistor, the third P-type transistor and the third N-type transistor coupled between a voltage bus and a ground connection; and a fourth P-type transistor and a fourth N-type transistor coupled between the voltage bus and the ground connection.

### BACKGROUND

Voltage converters are used in many electronic devices or systems to convert an input voltage into a lower voltage that is appropriate for use by device or system. Some conventional voltage converters, such as linear extendable group operated (LEGO) converters, include stacked switched capacitor units connected in series on the input side to extend its input voltage range. The conventional voltage converters also include multi-phase buck converter circuits connected in parallel on the output side to deliver a relatively high current and a large voltage conversion ratio. Although such conventional voltage converters are appropriate for power delivery solutions in many devices and systems, they are susceptible to conditions such as voltage stress during startup operation, load-dependent voltage ripple effect, and voltage and current imbalance in light load condition.

### BRIEF DESCRIPTION OF THE DRAWINGS

FIG. 1 shows a LEGO converter, according to some embodiments described herein.

FIG. 2 shows a single buck phase of a buck converter circuit of the LEGO converter of FIG. 1, according to some embodiments described herein.

FIG. 3 shows the LEGO converter of FIG. 1 during a startup mode, according to some embodiments described herein.

FIG. 4 is a timing diagram showing relationships between voltages during a startup mode and steady-state mode of the LEGO converter of FIG. 1, according to some embodiments described herein.

FIG. 5 is a flow diagram of an example method of operating a voltage converter, according to some embodiments described herein.

FIG. 6A shows another LEGO converter, according to some embodiments described herein.

FIG. 6B, shows an equivalent circuit highlighting a charging path of bootstrap capacitors of the LEGO converter of FIG. 6A, according to some embodiments described herein.

FIG. 7 shows simulated waveforms of the bootstrap capacitors of the LOGO converter of FIG. 6A, according to some embodiments described herein.

FIG. 8 is a flow diagram of a method of operating a voltage converter, according to some embodiments described herein.

FIG. 9 shows another LEGO converter including an SC circuit, according to some embodiments described herein.

FIG. 10A and FIG. 10B show two phases of operation of the SC circuit of FIG. 9, according to some embodiments described herein.

FIG. 11 and FIG. 12 are diagrams showing the bootstrap capacitor voltage of the SC circuit of FIG. 9, according to some embodiments described herein.

FIG. 13 is a flow diagram of a method of operating a voltage converter, according to some embodiments described herein.

FIG. 14 shows another LEGO converter, according to some embodiments described herein.

FIG. 15 is a graph showing an example of a simulated efficiency of the LEGO converter of FIG. 14, according to some embodiments described herein.

FIG. 16 is a flow diagram of a method of operating a voltage converter, according to some embodiments described herein.

FIG. 17 shows a block diagram of an apparatus in the form of an example machine (e.g., an electronic system), according to some embodiments described herein.

FIG. 18 is a flow diagram of a process of making a voltage converter, according to some embodiments described herein.

FIG. 19 is a flow diagram of another example of a process of making a voltage converter, according to some embodiments described herein.

### DETAILED DESCRIPTION

The techniques described herein involve voltage converters including LEGO converters. In an example, the described techniques provide solutions that keeps the high-side switch of Point-of-Load (PoL) PoL buck converter continuously on during startup. This provides a balancing path that keeps the PoL input voltages within limits during startup. After the startup is completed, the high-side switches can be changed (transitioned) into their regular operating mode as part of the buck converter.

In another example, the described techniques involve a LEGO converter that uses a series stack of lower voltage rated switches (e.g., transistors) with low drive voltage. The switches in the bootstrap capacitor charging path of the LEGO converter are realized using active transistors instead of passive diodes to limit the impact of their forward voltage drop on the drive voltage. In this example, the bootstrap voltages are established at startup by sequentially turning on the switches in the series stack and connecting them to ground.

In another example, different techniques are provided to mitigate the impact of load-dependent flying capacitor voltage ripple propagation on to the bootstrap capacitor of the LEGO converter. One technique involves structuring the bootstrap capacitors and other capacitors and other capacitors with appropriate sizes. Another technique involves actively modulating the bootstrap capacitor charging time.

In another example, the described techniques provide solutions to modify the frequency relationship between the switching frequencies of the buck and switched capacitor stages to extend the operation of the LEGO converter to light loads where Discontinuous Conduction Mode (DCM) can deliver higher efficiency. One technique involves modifying the mentioned frequency relationship in buck stage operation in DCM. Another technique involves modifying the mentioned frequency relationship in switched capacitor operation in DCM.

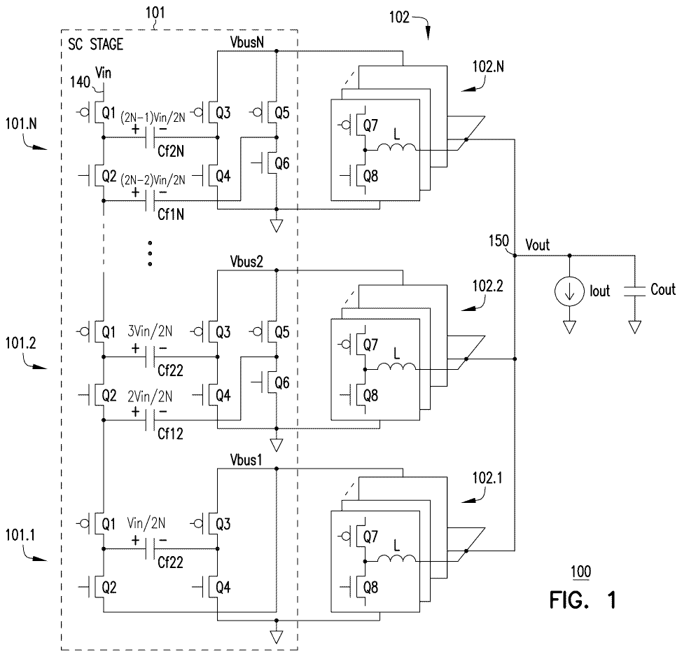

Improvements and benefits of the described techniques are discussed in more detail below with reference to FIG. 1 through 19.

FIG. 1 shows a LEGO converter 100, according to some embodiments described herein. LEGO converter 100 is a voltage converter that uses a cascaded 2-stage architecture to achieve a high conversion ratio. The cascade 2-stage architecture include a switched capacitor (SC) stage 101, and a buck stage 102. LEGO converter 100 can include a node (e.g., input node) 140 to receive a voltage (e.g., input voltage) Vin, and an output node 150 coupled to an output capacitor Cout. Output node 150 can provide a voltage (e.g., output voltage) Vout and a current Iout. The value of Vout is less than the value of Vin (Vout<Vin).

As shown in FIG. 1, SC stage 101 can include a number of SC dividers (e.g., 2:1 dividers) 101.1 through 101.N (N dividers) that are coupled (e.g., stacked up) in series, with each stack blocking a voltage of Vin/N. Each of SC dividers 101.1 through 101.N drives a single-phase (or alternatively multi-phase) buck (buck circuit) that runs off an input voltage of Vin/(2*N). SC dividers 101.1 through 101.N can also be called SC modules or alternatively SC circuits.

As shown in FIG. 1, SC dividers 101.1 through 101.N can include respective flying capacitors Cf12, and Cf22 through Cf1N and Cf2N, and respective transistors Q1, Q2, Q3, Q4, Q5, and Q6 coupled to each other and to other circuit elements of LEGO converter 100 as shown in FIG. 1. For example, flying capacitor Cf2N can be coupled to a node (e.g., the drain) shared by transistors Q1 and Q2, and coupled to a node (e.g., the drain) shared by transistors Q3 and Q4. In another example, flying capacitor Cf1N can be coupled to a node (e.g., the drain) shared by transistors Q5 and Q6. Transistors Q1 and Q2 of SC dividers 101.1 through 101.N can be coupled in series with each other between node 140 and Vbus1.

Transistors Q1, Q3, and Q5 can include P-type transistors (e.g., PMOS transistors). Transistors Q2, Q4, and Q6 can include N-type transistors (e.g., NMOS transistors). SC dividers 101.1 through 101.N are associated with N different outputs (voltage buses) Vbus1 through VbusN.

Buck stage 102 can include buck modules 102.1 through 102.N. Buck modules 102.1 through 102.N can also be called buck converter circuits. Each of buck modules 102.1 through 102.N can include a single-phase buck or multi-phase buck (e.g., M-phase where M>1), with each phase including a transistor Q7, a transistor Q8, and an inductor L coupled to each other and to other circuit elements of LEGO converter 100 as shown in FIG. 1. For example, in buck module 102.N, inductor L can be coupled to a node (e.g., the drain) shared by transistors Q7 and Q8. Transistor Q7 can include P-type transistors (e.g., PMOS transistor). Transistor Q8 can include an N-type transistors (e.g., NMOS transistor). Buck stage 102 can be part of a highly integrated PoL (e.g., FIVR). As shown in FIG. 1, buck modules 102.1 through 102.N of buck stage 102 can be coupled to output node 150 in parallel to deliver a current Iout, which can be a relatively large current.

By splitting up SC stage 101 into SC dividers 101.1 through 101.N (to have N different outputs Vbus1 through VbusN), charge-sharing losses can be minimized or eliminated in LEGO converter 100 and an inter-stage decoupling capacitor may be unnecessary. These features allow that LEGO converter 100 to have both smaller area and lower losses compared with an option (e.g., a baseline option) of having a similar standalone SC converter followed by a buck.

However, splitting up the SC to have multiple outputs (Vbus1 through VbusN) also makes the voltage balance between the flying capacitors (e.g., ensuring the average voltage across each flying capacitor is close to its expected value) sensitive to the load current drawn from each Vbus (among Vbus1 through VbusN). This is straightforward to achieve with the usual process, voltage, and temperature (PVT) tolerances in steady-state operation using a known frequency relationship between the buck and SC stages. However, during a startup (e.g., startup transient), a mismatch between the currents drawn by each buck may occur that may lead to voltage imbalance and electrical overstress (EOS).

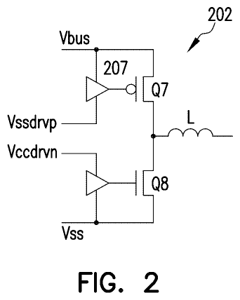

LEGO topology, including LEGO converter 100, opens up many possibilities when used with a high-bandwidth PoL converter, such as FIVR. By adding a dense SC stage upstream that can be integrated onto a package (e.g., integrated circuit package) since it may only be implemented with low Z-height capacitors, the input voltage of the converter can be increased substantially to realize platform-level benefits. These high-frequency buck converters on advanced CMOS nodes usually rely on a PMOS high-side device due to its comparable figure-of-merit to NMOS and the relative simplicity of a design that may not need a floating bootstrapped supply to support an NMOS high-side. The gate drivers of the high-side PMOS operate between the buck input (Vbus) and an internal driver floating reference voltage vssdrvp, as shown in FIG. 2.

FIG. 2 shows a single buck phase 202 with a PMOS transistor located on the high-side, according to some embodiments described herein. Buck phase 202 can also include an NMOS transistor located on the low-side, and gate drivers 207 and 208 to drive the gates of transistors PMOS and NMOS, respective. Gate driver 207 can operate at voltages Vbus and Vssdrvp (where Vbus and Vssdrvp are positive voltages). Gate driver 208 can operate at voltages Vssdrvn and Vss (ground). Buck phase 202 can be a single-phase buck of one of buck modules 102.1 through 102.N of buck stage 102 of FIG. 1. Vbus can be one of Vbus1 through VbusN of FIG. 1.

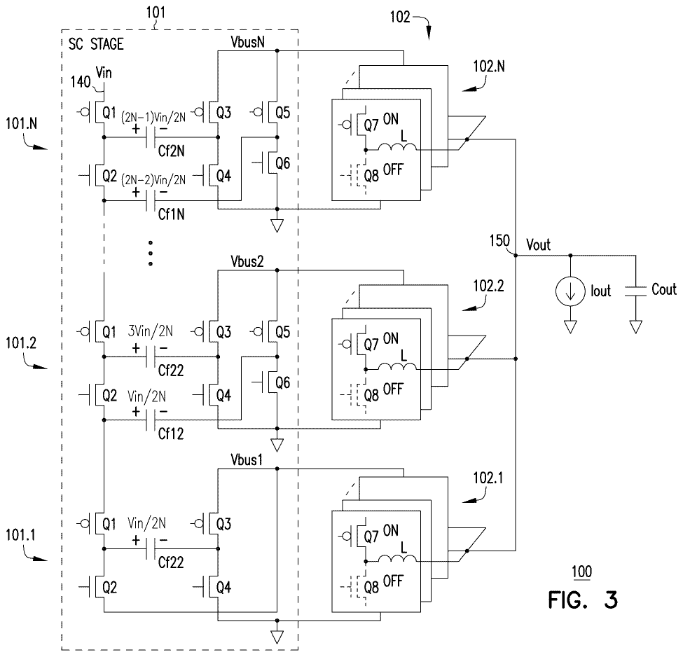

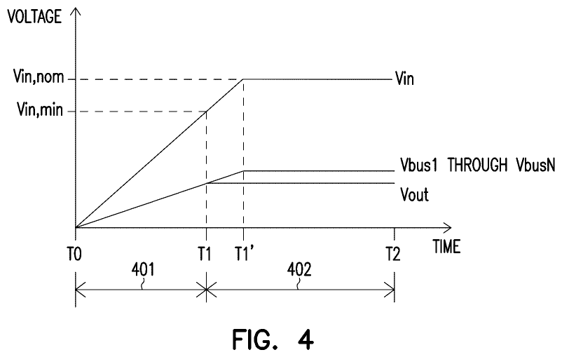

In a conventional technique, one way to solve a potential voltage balancing during startup in a LEGO (as mentioned above) is to keep the converter switching (e.g., keep transistors Q7 and Q8 switching) during the startup ramp as if it were in steady-state operation. Since the converter typically switch much faster than the ramp rates on the input, the conventional techniques are designed to ensure internal voltages maintain their relationship to each other during the ramp-up. However, for a buck with a PMOS transistor in the high-side (like transistor Q7 of FIG. 2), correct driver operation may not be guaranteed below a certain driver supply voltage (e.g., below a certain input voltage). Combined with PVT variation between the buck modules, this can lead to duty cycle distortion and a large variation in the current drawn from each Vbus during startup. This leads to voltage imbalance between the flying capacitors, and since the flying capacitor voltages can be much larger than the input of each buck, this can lead to some buck modules being exposed to a voltage that may be much larger than the voltage rating of the buck module. This can negatively impact operation of the converter during start up. The following description associated with FIG. 3 and FIG. 4, provides techniques for improvements and benefits associated with a startup mode of LEGO converter 100 of FIG. 1.

FIG. 3 shows LEGO converter 100 of FIG. 1 during a startup mode, according to some embodiments described herein. FIG. 4 is a timing diagram showing relationships between voltages during a startup mode and steady-state mode of LEGO converter 100 of FIG. 3. FIG. 4 shows a time interval 401 (e.g., from time T0 and to T1) and a time interval 402 (e.g., between times T1 and T2). The startup mode of LEGO converter 100 can occur during time interval 401. The steady-state mode (which occurs after the startup mode) can occurs during time interval 402. LEGO converter 100 can enter the startup mode at time T0 and exit the startup mode at time T1. LEGO converter 100 can enter the steady-state mode (e.g., after time T1 and before time T1′) after it exits the startup mode. Thus, LEGO converter 100 can change (e.g., make a transition) from the startup mode to the steady mode at time T1.

In an alternation configuration, as described below, LEGO converter 100 can enter the startup mode at time TO (FIG. 4) and exit the startup mode at time T1′ (instead of time T1). In the alternation configuration, LEGO converter 100 can enter the steady-state mode after it exits the startup mode (e.g., after time T1′). Thus, in the alternative configuration, LEGO converter 100 can change (e.g., make a transition) from the startup mode to the steady mode at time T1′ (instead of time T1).

In FIG. 3, label “ON” next to transistors Q7 (high-side PMOS transistor) indicated that transistor Q7 are turned on (conductive) during the startup mode (e.g., during time interval 401 in FIG. 4) of LEGO converter 100. Label “OFF” next to transistor Q8 (low-side NMOS transistor) indicates that transistors Q8 are turned off (not in conductive) during the startup mode of LEGO converter 100.

In FIG. 3, during the startup mode of LEGO converter 100, transistors Q7 are turned on to form a circuit path that coupled (e.g., shorts) Vbus1 through VbusN to each other at output node (at the common output of LEGO converter 100) at node 150. Turning on transistors Q7 during the startup mode can be done by applying a voltage to the gates of transistors Q7 (e.g., pulling down the gates of transistors Q7 to Vss) to cause transistors Q7 to conduct (turn on). Turning off transistor Q8 during the startup mode can be done by applying a voltage (e.g., Vss) to the gates of transistors Q8 (e.g., pulling down the gates of transistors Q8 to Vss) to cause transistors Q8 not to conduct (turn off).

When Vbus1 through VbusN are coupled (are shorted) to each other output node 150, LEGO converter 100 resembles a 2N:1 Dickson voltage divider, with the flying capacitors (e.g., flying capacitors Cf12, and Cf22 through Cf1N and Cf2N) voltages naturally settling to levels that are spaced apart by Vin/(2*N). This ensures that Vbus1 through VbusN voltages stay within the rated voltage during the startup mode (e.g., during the startup transient) during time interval 401 of FIG. 4.

In FIG. 4, voltage Vin,nom is a nominal value of voltage Vin. Voltage Vin,min is a selected voltage (e.g., a threshold voltage) that can be selected such that gate drivers (e.g., gate driver 207 in FIG. 2) for transistors Q7 (FIG. 3) can be considered as operating safely (having a proper operation as expected) when voltage Vin reaches voltage Vin,min (the selected voltage). As shown in FIG. 4, when voltage Vin reaches Vin,min (at which the gate drivers for transistors Q7 operate as expected), LEGO converter 100 (FIG. 3) can change from operating in the startup mode to operating in the steady-state mode (or operating in a fashion as if LEGO converter 100 is in the steady-state). For example, when voltage Vin reaches Vin,min (e.g., at time T1 in FIG. 4), transistors Q7 and Q8 can be controlled (turned on or turned off), such that voltage Vout can remain within a target value range (e.g., remain relatively unchanged, as shown in FIG. 4). In an alternative operation (e.g., an alternative configuration of LEGO converter 100), if a load (not shown in FIG. 3) coupled to node 150 can handle (can operate at) Vout=Vin,nom/(2*N), the startup mode be configured to run through the complete ramp of Vin until Vin reaches Vin,nom (e.g., at time T1′). Thus, in the alternative operation, LEGO converter 100 can remain in the startup mode until time T1′ (can be in the startup mode from time T0 to time T1′ (instead of time T1) and change to the steady-state mode after time T1′ (instead of after time T1).

LEGO converter 100 can provide improvements and benefits in comparison with some similar converters. For example, in some conventional converters rely on upstream converters on the platform that deliver the input voltage of the PoL converter (e.g., FIVR) as a regulated, well-controlled supply. As such, the PoL converter does not see transient over-voltage events at its input during startup. However, these solutions do not address the fundamental need to reduce the input current into the socket. They are typically not dense enough or rely on tall components that preclude them from being integrated into the package. A typical approach to solving similar issues would be to keep the converter operating while the input ramps up. This ensures that internal voltages which are defined as a fixed ratio of the input, stay within the design limits as the input ramps up to its specified value. However, this approach assumes that the drivers for each switch operate from a separate supply that is established before the input ramp. It also does not work for converters where the input supply also acts as the driver supply (e.g., the PMOS high-side switch in FIVR). Another approach could be to have an auxiliary circuit that establishes all internal voltages during startup. This approach has the obvious drawback of requiring additional silicon area and/or passive components that only get used during startup.

In LEGO converter 100, as described above, the startup mode operation keeps transistors Q7 (the high-side switches) of buck modules 102.1 through 102.N continuously turned on. After the startup is completed (e.g., after time T1 in FIG. 3), transistors Q7 can be transitioned into their regular operating mode as part of normal operation of In LEGO converter 100. The startup operation of LEGO converter 100 is provides a balancing path that keeps the PoL input voltages within limits during startup, thereby improving startup operation of LEGO converter 100 over some similar conventional converters.

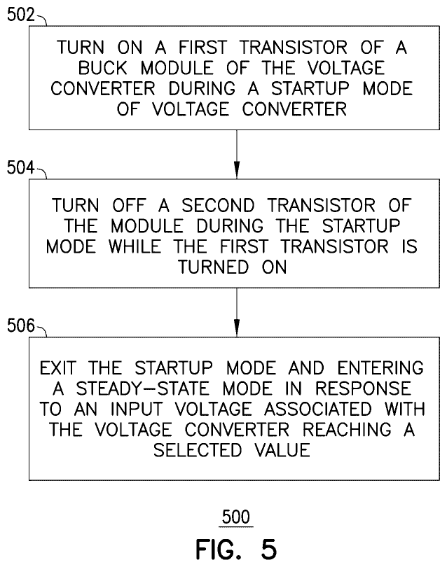

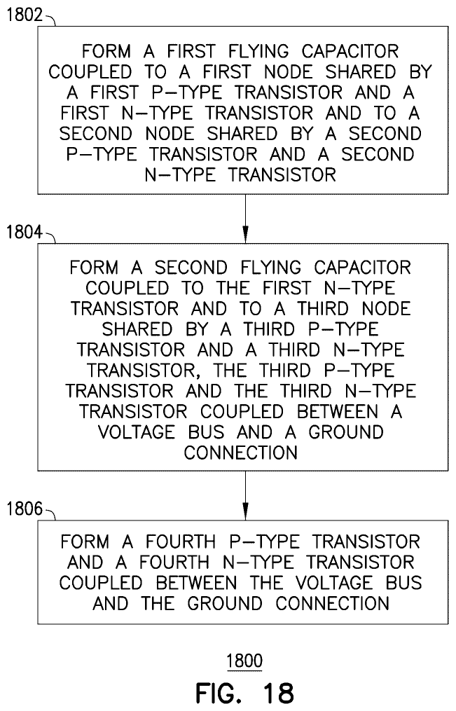

FIG. 5 is a flow diagram of a method 500 of operating a voltage converter, according to some embodiments described herein. The voltage converter associated with method 500 can include LEGO converter 100 of FIG. 1. As shown in FIG. 5, method 500 can include operations 502 and 504, which may be executed by an embedded controller or another processor of a computing device (e.g., hardware processor 1702 of machine 1700 illustrated in FIG. 17, which can include one or more of the circuits discussed in connection with FIG. 1 through FIG. 4. In some embodiments, one or more of the circuits discussed in connection with FIG. 1 through FIG. 4 can perform the functionalities (e.g., operations) shown in FIG. 5 and in the examples listed below.

In FIG. 5, operation 502 can include entering a startup mode (e.g., at time TO in FIG. 4) in the voltage converter, the voltage converter including a buck stage, the buck stage including P-type transistors (e.g., transistors P7 in FIG. 3) coupled to N-type transistors (e.g., transistors P8 in FIG. 3).

Operation 504 can include turning on the P-type transistors during the startup mode and turning off the N-type transistors during the startup mode. The P-type transistors can be continuously turned on (e.g., not turned off) during the startup mode.

Operation 506 can include exiting the startup mode (e.g., at time T1 or time T1′ in FIG. 4) in response to an input voltage reaches a selected voltage (e.g., either Vin,min or Vin,nom in FIG. 4). The selected voltage can be less than or equal to the input voltage.

Method 500 can include fewer or more operations than the operations shown in FIG. 5. For example, method 500 can include operations of LEGO converter 100 described above with reference to FIG. 1 through FIG. 4. Method 500 can also include operations described in the examples listed below.

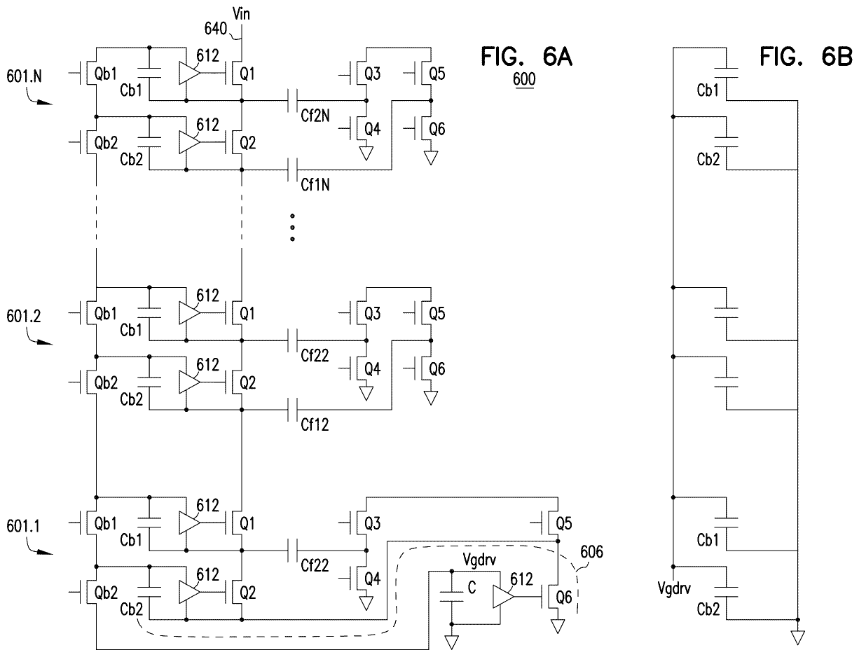

FIG. 6A shows a LEGO converter 600, according to some embodiments described herein. LEGO converter 600 is a voltage converter. LEGO converter 600 can include elements similar to those of LEGO converter 100. For simplicity, only a portion of LEGO converter 600 is shown in FIG. 6A. LEGO converter 600 can include SC modules 601.1 through 601.N, which can also be called SC circuits. Each of SC modules 601.1 through 601.N can have respective flying capacitors Cf12, and Cf22 through Cf1N and Cf2N, and respective transistors (e.g., switches) Q1, Q2, Q3, Q4, Q5, and Q6 coupled to each other and to other circuit elements of LEGO converter 600 as shown in FIG. 6A. Transistors Q1, Q2, Q3, Q4, Q5, and Q6 can include N-type transistors (e.g., NMOS transistors). However, at least some of transistors Q1 through Q6 can be P-type transistors.

Each of SC modules 601.1 through 601.N can also include respective gate driver 612 to drive the gates of respective transistors Q1 and Q2. SC modules 601.1 through 601.N can also include respective bootstrap circuits that include respective bootstrap capacitors Cb1 and Cb2 and transistors (e.g., switches) Qb1 and Qb2 coupled to each other and to other circuit elements of LEGO converter 600 as shown in FIG. 6A. For example, transistors Qb1 and Qb2 of SC modules 601.1 through 601.N can be coupled in series with each other on a circuit path, in which the circuit path includes transistors Qb1 and Qb2 and a node (e.g., supply node) that receives voltage (e.g., supply voltage) Vgdrv. Transistors Qb1 and Qb2 can include N-type transistors (e.g., NMOS transistors). In FIG. 6A, one bootstrap capacitor Cb1 and one transistor Qb1 can be part of a bootstrap circuit. One bootstrap capacitor Cb2 and one transistor Qb2 can be part of another bootstrap circuit. As shown in FIG. 6A, SC module 601.1 can include capacitor C associated with Vgdrv that provides supply voltage for a gate driver 616. Gate driver 616 drives the gate of transistor Q6 of SC module 601.1

As shown in FIG. 6A, transistors Q1 and Q2 of SC modules 601.1 through 601.N can be coupled in a series stack with respect to node 640, which can receive voltage Vin. In FIG. 6A, generating the gate drive supply voltages (e.g., bootstrap voltages) for transistors Q1 and Q2 can be challenge because the sources of transistors Q1 and Q2 do not share a common ground. Moreover, establishing these bootstrap voltages at startup can be even more challenging because bootstrap switches (transistors Qb1 and Qb2) can be difficult to be replaced with passive diodes because their diode forward voltage drop will leave very little voltage at the bootstrap rail for the switches to be turned on.

The following techniques provide a way solve the above-mentioned challenges. In an example, LEGO converter 600 can be configured to turn on (e.g., sequentially turn on) transistors Q1 and Q2 in the series stack and couple them to ground. Coupling transistors Q1 and Q2 to ground can be performed by turning on the ground referenced transistor Q6 of SC module 601.1. Sequentially turning on transistors Q1 and Q2 can sequentially (from SC module 601.1 to SC module 601.N) couple bootstrap capacitors Cb1 and Cb2 to Vgdrv. Thus, bootstrap capacitors Cb1 and Cb2 can sequentially (and progressively) be charged to Vgdrv, as explained below.

Turning on transistors Q6 of SC module 601.1 creates a charging path for the bootstrap capacitor of the transistor (transistor Q2 of SC module 601.1) above it in the stack of transistors Q1 and Q2, as shown by dashed path. Bootstrap capacitor Cb2 of SC module 601.1 is charged by Vgdrv (the ground referenced gate drive supply voltage) through the transistors Qb2 and Q6. After the voltage across the bootstrap capacitor Cb2 of SC module 601.1 is established, transistor Q2 of SC module 601.1 can turn on. Turning on transistor Q2 of SC module 601.1 creates the charging path for the bootstrap capacitor of the transistor above it, Cb1 (Cb2-Qb1-Cb1-Q2) and it can charge up to Vgdrv in a similar fashion as Cb2. This approach is scalable to a stack with large number of transistors (e.g., switches) because the bootstrap capacitors are charged using active transistors and not diodes. This results in negligible loss in voltage at the bootstrap rail.

FIG. 6B, shows the equivalent circuit highlighting the charging path of bootstrap capacitors Cb1 and Cb2 of the stacked switches in steady-state mode after transistors Q1 and Q2 in the series stack are turned on. Bootstrap capacitors Cb1 and Cb2 will attain a target voltage (e.g., desired voltage) of Vgdrv at the end of this precharge period.

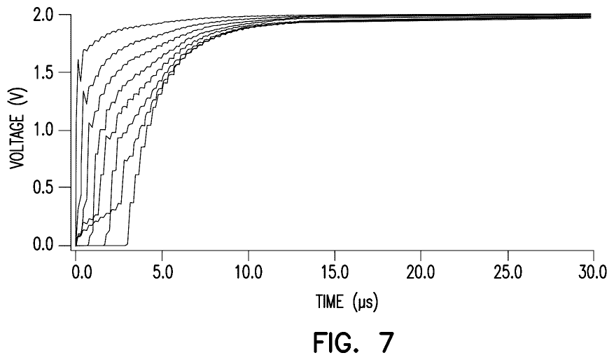

FIG. 7 shows simulated waveforms of the bootstrap capacitors Cb1 and Cb2 of an example of four-stack (N=4) Dickson switched capacitor modules 601.1 through 601.N (where N=4) using the techniques described above with reference to FIG. 6A. FIG. 7 shows eight waveforms associated with eight bootstrap rails (associated with four bootstrap capacitors Cb1 and four bootstrap capacitors Cb2 for the example of N=4). As shown in FIG. 7, bootstrap capacitors Cb1 and Cb2 (FIG. 6A) are sequentially (and progressively) charged up and attaining the same voltage of Vgdrv (2V in this example) at the end of the precharge period. The techniques described here can also be suitable to be integrated into a voltage regulator (VR) die without significantly occupying area overhead.

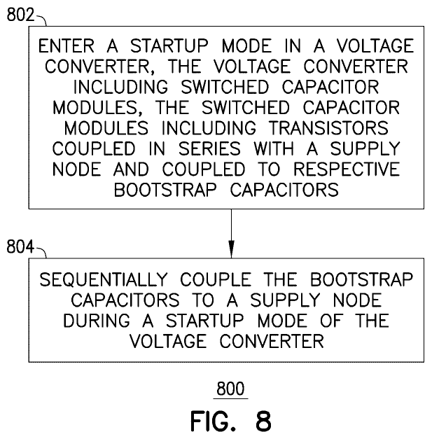

FIG. 8 is a flow diagram of a method 800 of operating a voltage converter, according to some embodiments described herein. The voltage converter associated with method 800 can include LEGO converter 600 of FIG. 6A. As shown in FIG. 8, method 800 can include operations 802 and 804, which may be executed by an embedded controller or another processor of a computing device (e.g., hardware processor 1702 of machine 1700 illustrated in FIG. 17, which can include one or more of the circuits discussed in connection with FIG. 6A and FIG. 7. In some embodiments, one or more of the circuits discussed in connection with FIG. 6A and FIG. 7 can perform the functionalities (e.g., operations) shown in FIG. 8 and in the examples listed below.

In FIG. 8, operation 802 can include entering a startup mode in a voltage converter (e.g., LEGO converter 600 in FIG> 6), the voltage converter including switched capacitor modules, the switched capacitor modules including transistors coupled in series with a supply node (e.g., node associated with Vgdrv in FIG. 6A) and coupled to respective bootstrap capacitors (e.g., Cb1 and Cb2). Operation 804 can include sequentially coupling the bootstrap capacitors to a supply node during a startup mode of the voltage converter.

Method 800 can include fewer or more operations than the operations shown in FIG. 8. For example, method 800 can include operations of LEGO converter 600 described above with reference to FIG. 6A and FIG. 7. Method 800 can also include operations described in the examples listed below.

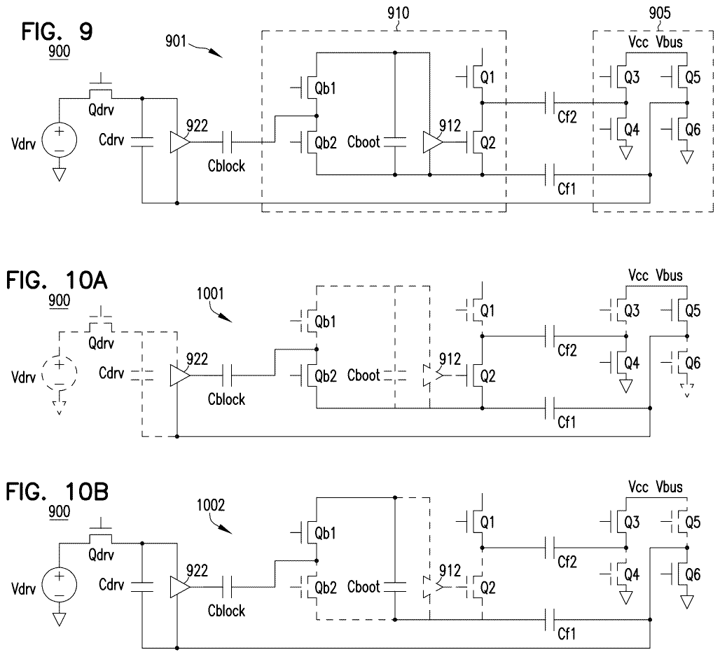

FIG. 9 shows a LEGO converter 900, according to some embodiments described herein. LEGO converter 900 is a voltage converter that can include elements similar to those of LEGO converters 100 and 600. For simplicity, FIG. 9 shows only a portion of LEGO converter 900 that include SC module (or switched capacitor circuit) 901, which can be similar to one of SC modules 101.1 through 101.N (FIG. 1) or 601.1 through 601.N (FIG. 6A).

As shown in FIG. 9, SC module 901 can include a high-voltage (HV) side 910 and a low-voltage (LV) side 905. HV side 910 can include transistors Q1, Q2, Q1b, Q2b, a gate driver 912, and a bootstrap capacitor Cboot coupled to each other and to other circuit elements of LEGO converter 900 as shown in FIG. 9. LV side 905 can include transistors Q3, Q4, Q5, and Q6. SC module 901 can also include flying capacitors Cf1 and Cf2 coupled between HV side 910 and LV side 905. SC module 901 can also include a capacitor (e.g., a relatively high voltage blocking capacitor) Cblock, a driver 922, a capacitor Cdrv, and a transistor Qdrv. SC module 901 can be couple to a voltage source to receive a voltage Vdrv, and a voltage source to receive a voltage VccVbus.

LEGO converter 900 has features that are suitable for many power delivery architectures. Such features include large voltage step-down capability, high efficiency, and high current density. However, without a voltage ripple mitigation techniques describe below, bootstrap capacitors (e.g., bootstrap capacitor Cboot in FIG. 9) in HV side 910 of LEGO converter 900 is susceptible to the load-dependent voltage ripple in its flying capacitors (e.g., flying capacitors Cf1 and Cf2). If left unmitigated, this voltage ripple (which can reach a value, e.g., in the order of a few volts) can be catastrophic to the voltage regulating operation of LEGO converter 900 because the switches (e.g., transistors Q1 through Q6) of LEGO converter 900 rely on a steady drive voltage for safe operation. The description below provides techniques to minimize the flying capacitor voltage ripple propagation on to the bootstrap capacitor.

FIG. 10A and FIG. 10B shows two phases 1001 and 1002, respectively, of operation of SC module 901 of LEGO converter 900 of FIG. 9. In phase 1001 (FIG. 10A), Cblock gets charged to the voltage of the flying capacitor Cf2 as indicated by the highlighted path. In phase 1002 (FIG. 10B), Vdrv, Cblock, Cboot, and Cf2 appear in series. Since, Cblock has already assumed the voltage of Cf2 in phase 1001 (FIG. 10A), Cboot in phase 1002 gets charged to Vdrv. As shown in FIG. 10B, SC module (SC circuit 901) include a circuit path, which includes capacitor Cblock, transistor Qb1, bootstrap capacitor Cboot, and flying capacitor Cf2. As shown in FIG. 10B, capacitor Cblock is coupled in series with bootstrap capacitor Cboot and flying capacitor Cf2.

This bootstrapping scheme is suitable in situations where the load dependent voltage ripple in the flying capacitor is negligible compared with the gate drive voltage Vdrv. However, in a design that aims to improve (e.g., maximize) the current density of the LEGO converter 900, the voltage ripple in the flying capacitor Cf2 can be significant and comparable with the gate drive voltage itself. In such a scenario, during phase 1002 in FIG. 10B, the voltage across the flying capacitor Cf2 can drop significantly. This leads to a situation where the bootstrap rail may have a voltage much greater than the safe limit of operation at the bootstrap rail. Moreover, due to the load dependent nature of in this situation, simply reducing the Vdrv level to absorb the flying capacitor voltage ripple may not work across the entire load range.

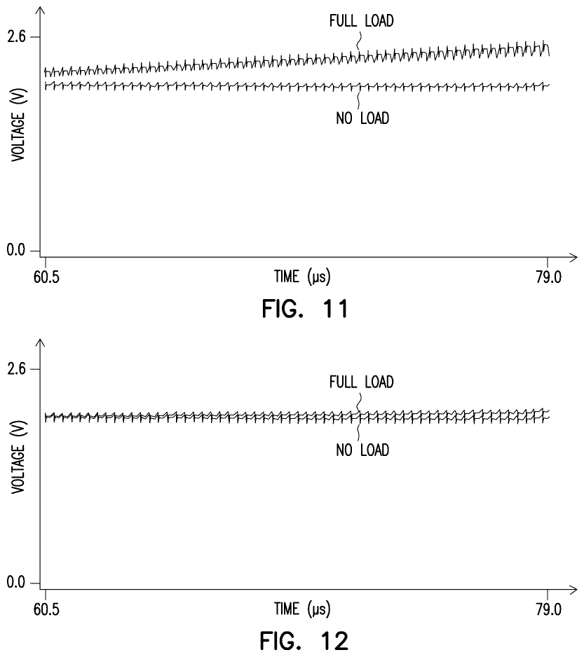

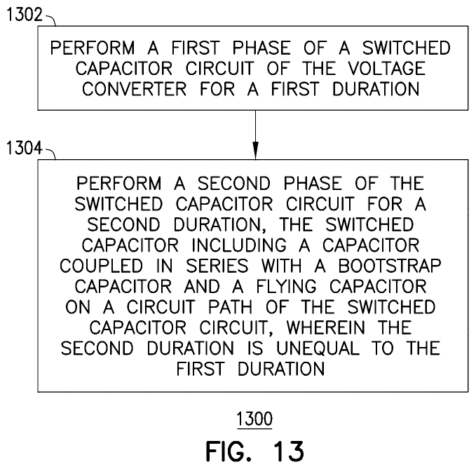

FIG. 11 is a diagram showing the bootstrap capacitor voltage at HV side 910 (at no load and full load) without the techniques described below. As shown in FIG. 11, at full load, the bootstrap capacitor voltage can be seen to be deviating significantly from the desired gate drive voltage.

The following description provides techniques to mitigate (e.g., minimize) the flying capacitor voltage ripple propagation on to the bootstrap rail. One technique involves appropriately sizing (e.g., increasing the size) of the bootstrap capacitor relative to another capacitor (e.g., capacitor Cblock) in the charging path that which blocks the flying capacitor voltage. Another technique involves actively modulating the charging time of the bootstrap capacitor.

Relative sizing of blocking capacitor Cblock and bootstrap capacitor Cboot can involve the following. In phase 1002 of SC module 901 described above with reference to FIG. 10B, the voltage ripple of the flying capacitor Cf2 is distributed across Cblock and Cboot. Cblock and Cboot represent a voltage divider to this ripple. To ensure that Cboot sees less of this ripple, Cboot can be sized to be much bigger than Cblock, so that Cblock absorbs bulk of the flying capacitor voltage ripple.

Active modulation of the charging time of the bootstrap capacitor involves the following. The charging time of the bootstrap capacitor Cboot can be reduced actively (reducing time duration of phase 1002 in FIG. 10B), so that phase 1002 does not see the complete peak-to-peak flying capacitor voltage ripple, thereby reducing the voltage rise at Cboot. In an example, the maximum switching frequency of the SC module 901 of LEGO converter 900 can be limited to a few MHz due to limitations imposed by passives and routing parasitics. This switching frequency translates to more than 100 nanoseconds (>100 ns) of time for each of the two equally sized half-cycles of the SC stage. The bootstrap capacitor charging time does not need to be as long as the half cycle time duration to complete its charging, and the shorter the charging time the less the propagation of the flying capacitor voltage ripple on to the bootstrap capacitor.

Thus, in the described techniques, phase 1002 can have a cycle time less than that of phase 1001. For example, without the described techniques, phase 1001 and phase 1002 may have an equal cycle time. In an example, without the described techniques, the cycle time of each of phase 1001 and phase 1002 can be one-half of the cycle time (switching time) of SC module 901. With the described techniques, phase 1001 and phase 1002 can have unequal cycle times, in which the cycle time of phase 1002 can be less the cycle time of phase 1001. For example, phase 1001 can be performed (can be active) for a duration of T amount of time (where T is measure in time units) and phase 1002 can be performed in a duration of X*T (where “*” indicates multiplication, and X is a number less than one, X<1).

The active modulation technique described here can be performed in closed loop to ensure that the bootstrap capacitor voltage is regulated at the target value across the entire load range of operation. As the load increases, the controller (not shown) of LEGO converter 900 can operate to reduce the charging time of the bootstrap capacitor to regulate its voltage.

FIG. 12 is a diagram showing the bootstrap capacitor voltage at HV side 910 (at no load and full load) after LEGO converter 900 includes the two techniques described above to limit the flying capacitor voltage ripple propagation. In this example, the Cboot is sized to be ten times bigger than Cblock and the charging time of Cboot is limited to less than half (e.g., about 10%) of the switching time period of SC module 901. By comparing the diagrams in FIG. 11 and FIG. 12, the variation in the Cboot voltage across the load range is significantly reduced, as shown in FIG. 12.

The active modulation technique described above can also be performed in closed loop to ensure that the bootstrap capacitor voltage is regulated at the target value across the entire load range of operation. As the load increases the controller of LEGO converter 900 can operate to reduce the charging time of the bootstrap capacitor to regulate its voltage.

With the techniques described above, LEGO converter 900 can provide a way for elimination of some components (e.g., low-dropout (LDO) circuits) that may be included in the bootstrap rails voltage converter, such as LEGO converter 900. Elimination of such components can make LEGO converter 900 cost effective and compact. Further, the techniques described above allow the driver supply voltage of LEGO converter 900 to be just as much as (and no greater than) what is needed by the transistors, thus improving the efficiency of LEGO converter 900.

FIG. 13 is a flow diagram of a method 1300 of operating a voltage converter, according to some embodiments described herein. The voltage converter associated with method 1300 can include LEGO converter 900 of FIG. 9. As shown in FIG. 13, method 1300 can include operations 1302 and 1304, which may be executed by an embedded controller or another processor of a computing device (e.g., hardware processor 1702 of machine 1700 illustrated in FIG. 17, which can include one or more of the circuits discussed in connection with FIG. 6A and FIG. 7. In some embodiments, one or more of the circuits discussed in connection with FIG. 9 through FIG. 12 can perform the functionalities (e.g., operations) shown in FIG. 13 and in the examples listed below.

In FIG. 13, operation 1302 can include performing a first phase (e.g. phase 1001 in FIG. 10A) of a switched capacitor circuit (e.g., SC module 901) of the voltage converter for a first duration. Operation 1304 can include performing a second phase (e.g., phase 1002) of the switched capacitor circuit for a second duration, the switched capacitor including a capacitor (e.g., Cblock in FIG. 9) coupled in series with a bootstrap capacitor (e.g., Cboot in FIG. 9) and a flying capacitor on a circuit path of the switched capacitor circuit. The second duration is unequal to the first duration. In an example, the second duration is less than the first duration.

Method 1300 can include fewer or more operations than the operations shown in FIG. 13. For example, method 1300 can include operations of LEGO converter 600 described above with reference to FIG. 9 through FIG. 12. Method 1300 can also include operations described in the examples listed below.

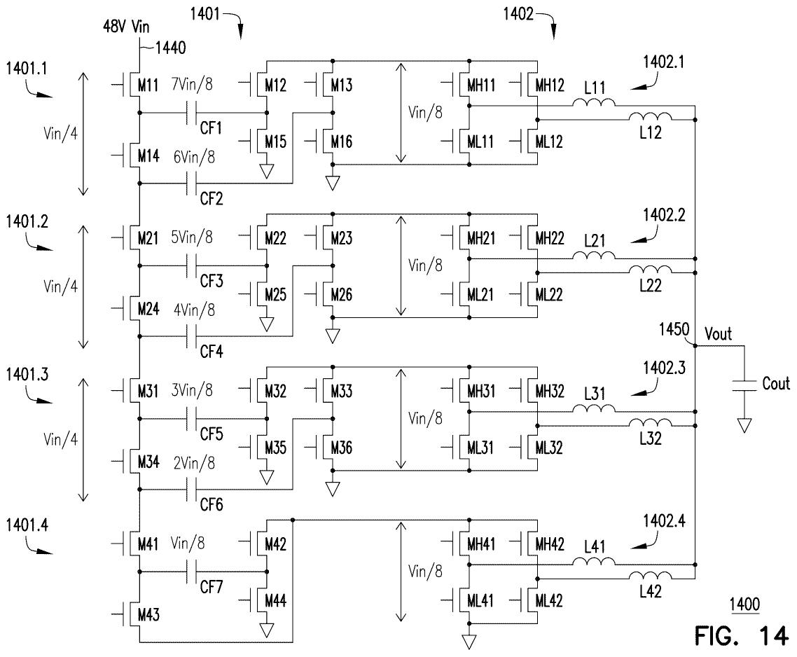

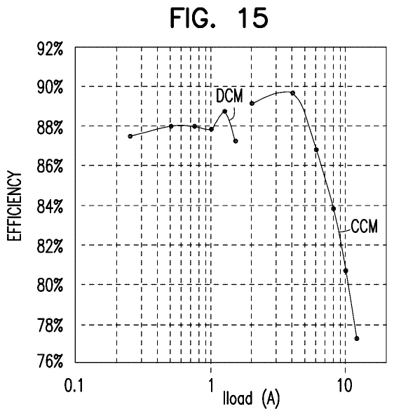

FIG. 14 shows a LEGO converter 1400, according to some embodiments described herein. LEGO converter 1400 is a voltage converter. LEGO converter 1400 can include a switched capacitor (SC) stage 1401, and a buck stage 1402. LEGO converter 1400 can include an input node 1440 to receive a voltage (e.g., input voltage) Vin, and an output node 1450 coupled to an output capacitor Cout. Output node 150 can provide a voltage (e.g., output voltage) Vout. The value of Vout is less than the value of Vin (Vout<Vin).

As shown in FIG. 14, SC stage 1401 can include a number of SC dividers (e.g., 2:1 dividers) 1401.1 through 1401.4 (e.g., four SC 2:1 dividers), which can also be called SC circuits. Buck stage 1402 can include buck modules 1402.1 through 1402.4, which can also be called buck converter circuits, coupled (e.g., stacked up) in series, with each stack blocking a voltage of Vin/4. Each of buck modules 1402.1 through 1402.4 can include two phases (e.g., interleaved phases) that are coupled in parallel at output node 1450. SC dividers 1401.1 through 1401.4 drives two-phase buck module (buck circuit) that runs off an input voltage of Vin/8.

FIG. 14 shows an example where LEGO converter 1400 includes a 48V input voltage (e.g., Vin=48V), N=4 SC dividers 1401.1 through 1401.4, and M=2 phases in each of buck modules 1402.1 through 1402.4. However, LEGO converter 1400 can include a different number of SC dividers (e.g., N is different from 4) and a different number of M phases (e.g., M is different from 2).

As shown in FIG. 14, SC dividers 1401.1 through 1401.4 can include respective flying capacitors and respective transistors. For example, SC divider 1401.1 can include flying capacitors CF1 and CF2, and transistors M11, M12, M13, M14, M15, and M16. SC divider 1401.2 can include flying capacitors CF3 and CF4, and transistors M21, M22, M23, M24, M25, and M26. SC divider 1401.3 can include flying capacitors CF5 and CF6, and transistors M31, M32, M33, M34, M35, and M36. SC divider 1401.4 can include flying capacitor CF7, and transistors M41, M42, M43, and M44. The voltages associated with the flying capacitors (e.g., 7Vin/8 associated with flying capacitor CF1) are based on the example of N=4 SC dividers.

As shown in FIG. 14, each of buck modules 1402.1 through 1402.4 can include respective inductors and transistors. For example, buck module (buck converter circuit) 1402.1 can include transistors ML11, ML12, and inductor L11, forming one phase (phase circuit) of buck module 1402.1, and transistors MH11, MH12, and inductor L12, forming another phase (phase circuit) of buck module 1402.1.

Buck module (buck converter circuit) 1402.2 can include transistors ML21, ML22, and inductor L21, forming one phase (phase circuit) and transistors MH21, MH22 of buck module 1402.2, and inductor L22, forming another phase (phase circuit) of buck module 1402.2.

Buck module (buck converter circuit) 1402.3 can include transistors ML31, ML32, and inductor L31, forming one phase (phase circuit) and transistors MH31, MH32 of buck module 1402.3, and inductor L32, forming another phase (phase circuit) of buck module 1402.3.

Buck module (buck converter circuit) 1402.4 can include transistors ML41, ML42, and inductor LA1, forming one phase (phase circuit) of buck module 1402.4, and transistors MH41, MH42, and inductor L42, forming another phase (phase circuit) of buck module 1402.3.

The transistors of LEGO converter 1400 shown in FIG. 14 can be called switches and can include N-type transistors (e.g., NMOS transistor). However, at least some of the transistors of LEGO converter 1400 can be P-type transistors.

The structure of LEGO converter 1400 as shown in FIG. 14 can have a relatively large input voltage range and can deliver a relatively high current, both of which allow LEGO converter 1400 to provide a large conversion ratio (e.g., Vin=48V to Vout=1V). To maintain voltage and current balancing among the SC dividers of SC stage 1401 and the buck modules of buck stage 1402, their switching frequencies are designed to satisfy certain conditions. However, such conditions may break down in some situations, such as in light-load where the buck stage 1402 operates in DCM using a variable-frequency control scheme, such as Pulse-Frequency Modulation (PFM) or Pulse-Skipping Modulation (PSM).

The description below provides techniques that modify the frequency relationship between the switching frequencies of buck stage 1402 and SC stage 1401. Two conditions are involved in order to ensure current and voltage balancing in a variable frequency mode of operation. In one condition, a droop in the signal (e.g., Vout) at output node 1450 falling below a reference (e.g., outside a target range) can cause a triggering of the same number of inductor current pulses (e.g., P) across active phases in every stack. In another condition, the SC stage 1401 may be configured to be triggered once per Q output voltage droop events. The number of SC dividers (N) and phases (M) can be adjusted based on target (e.g., desired) output ripple and light-load efficiency specifications.

In order to maintain voltage balancing across SC dividers 1401.1 through 1401.4 (such that each divider has the same average voltage across its input and output) and current balancing between the buck phases in buck modules 1402.1 through 1402.4, the switching frequencies of the two can be expressed as follows.

$${f}_{s w - buck} = \frac{2 d}{M} {f}_{s w - S C}$$

where d is an odd number that is co-prime with M. However, this relationship often works in continuous-conduction mode (CCM), where the inductor continuously conducts current. In light-load conditions, LEGO converter 1400 is configured to operate buck stage 1402 in DCM, where the inductor current is kept at zero for a portion of the switching cycle. During this portion, the transistors in buck stage 1402 are configured to be non-conductive (e.g., not to switch), thereby eliminating both switching and conduction losses in the converter. The inductor current then resembles a series of triangular pulses that get triggered whenever the output voltage (e.g., Vout) goes below a target set point (e.g., a desired set point), which increases or decreases in frequency as the load current increases or decreases. Since power is often dissipated in the converter when the switches are being switched and current is flowing, the power losses scale with the output voltage, thus maintaining constant efficiency across a wide range of load currents.

In DCM, the switching frequency of buck stage 1402 may not be a fixed value. Thus, a separate scheme can be devised to lock the effective switching frequency of SC stage 1401 to that of buck stage 1402. In the techniques described herein, to extend the operation of LEGO converter 1400 to light loads where DCM can deliver higher efficiency, the operation of LEGO converter 1400 can be configured (e.g., modified) using two techniques described in detail below.

One technique involves performing buck stage operation of buck stage 1402 in DCM. In this operation, within each stack, a single phase (phase circuit) of the buck is kept active (e.g., transistors in the active phase are switching) while (in response to) the other phase (or other phases) of the buck can be disabled (e.g., transistors in the disable phase are not switching). When the output voltage (e.g., Vout) droops below a reference, the active phase in each stack is triggered P times to generate an equal number of triangular inductor current pulses going into the common output at output node 1450. This ensures that the input of each buck module (or the output of each SC divider) loses an equal amount of charge. The inductor current pulses from each stack of the LEGO converter 1400 may or may not overlap partially or completely with each other. Further, the active phase in each stack may map to a single physical phase in the multi-phase buck in each stack or may be periodically rotated through the physical phases in order to ensure each physical phase sees uniform time-averaged current and voltage stress.

Another technique involves performing switched capacitor operation of SC stage 1401 in DCM. In this operation, SC stage 1401 can be configured (e.g., programmed) to go through an entire switching cycle every Q triggering events where the output voltage drops below the reference. Since the switched capacitor stage has 2 phases of operation, Q can ideally be an even number, with each phase of operation lasting Q/2 triggering events. Locking the switched capacitor stage's period of operation to the output triggers (which is tied to the inductor current pulses) ensures that each buck input across the stacks has an equal amount of charge that needs to be replenished. This ensures they are all balanced and the capacitor voltages maintain their expected voltage across them.

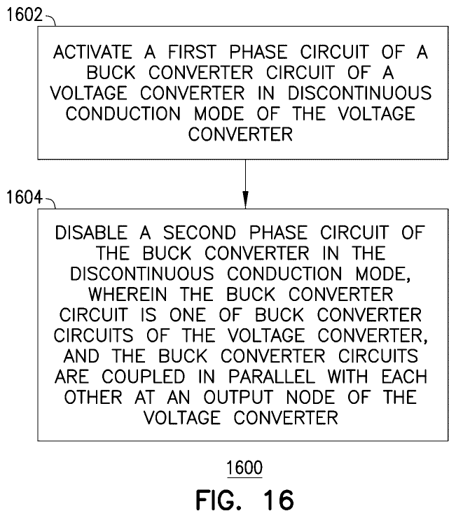

FIG. 15 is a graph showing an example of a simulated efficiency of LEGO converter 1400 that operates using the techniques described above with reference to FIG. 14. In FIG. 15 curves DCM and CCM are associated with DCM and CCM operations, respectively, of LEGO converter 1400 of FIG. 14. As shown in FIG. 15, LEGO converter 1400 can maintain a relative high efficiency as it goes deep into DCM. By extending the high-efficiency region of operation of LEGO converter 1400 to extremely light loads, as described above, LEGO converter 1400 can have a wider dynamic range of load currents for the converter. This allows LEGO converter 1400 suitable for many electronic devices and systems where idle power may play a key factor.

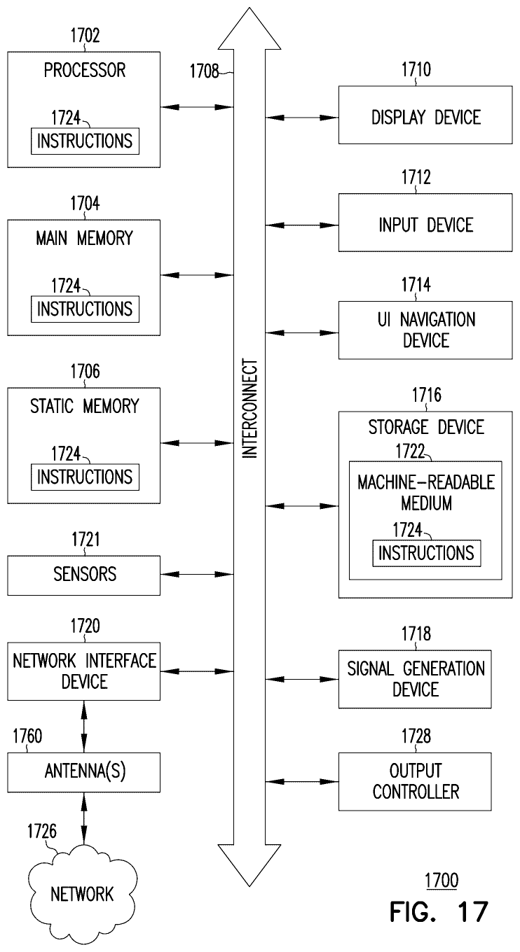

FIG. 16 is a flow diagram of a method 1600 of operating a voltage converter, according to some embodiments described herein. The voltage converter associated with method 1600 can include LEGO converter 1400 of FIG. 14. As shown in FIG. 16, method 1600 can include operations 1602 and 1604, which may be executed by an embedded controller or another processor of a computing device (e.g., hardware processor 1702 of machine 1700 illustrated in FIG. 16, which can include one or more of the circuits discussed in connection with FIG. 6A and FIG. 7. In some embodiments, one or more of the circuits discussed in connection with FIG. 14 can perform the functionalities (e.g., operations) shown in FIG. 16 and in the examples listed below.

In FIG. 16, operation 1602 can include activating a first phase circuit of a buck converter circuit of a voltage converter in discontinuous conduction mode of the voltage converter. Operation 1604 can include disabling a second phase circuit of the buck converter in the discontinuous conduction mode. The buck converter circuit is one of buck converter circuits of the voltage converter. The buck converter circuits are coupled in parallel with each other at an output node of the voltage converter.

Method 1600 can include fewer or more operations than the operations shown in FIG. 16. For example, method 1600 can include operations of LEGO converter 600 described above with reference to FIG. 14. Method 1600 can also include operations described in the examples listed below.

FIG. 17 shows a block diagram of an apparatus in the form of an example machine (e.g., an electronic system) 1700 upon which any one or more of the techniques (e.g., methodologies) discussed herein may perform. In alternative embodiments, the machine 1700 may operate as a standalone device or may be connected (e.g., networked) to other machines. In a networked deployment, machine 1700 may operate in the capacity of a server machine, a client machine, or both in server-client network environments. In an example, machine 1700 may function as a peer machine in a peer-to-peer (P2P) (or other distributed) network environment. The machine 1700 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is shown, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

The apparatus including machine 1700 may be configured to perform one or more of the methods and/or operations disclosed herein. The apparatus may be intended as a component of machine 1700 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

Machine (e.g., computer system) 1700 may include a hardware processor 1702 (e.g., a central processing unit (CPU), a graphics processing unit (GPU), a hardware processor core, or any combination thereof), a main memory 1704, and a static memory 1706, some or all of which may communicate with each other via an interconnect (e.g., bus) 1708. In some aspects, main memory 1704, static memory 1706, or any other type of memory (including cache memory) used by machine 1700 can be configured based on the disclosed techniques or can implement the disclosed memory devices.

Specific examples of main memory 1704 include Random Access Memory (RAM) and semiconductor memory devices, which may include, in some embodiments, storage locations in semiconductors such as registers. Specific examples of static memory 1706 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 1700 may further include a display device 1710, an input device 1712 (e.g., a keyboard), and a user interface (UI) navigation device 1714 (e.g., a mouse). In an example, display device 1710, input device 1712, and UI navigation device 1714 may be a touchscreen display. The machine 1700 may additionally include a storage device (e.g., drive unit or another mass storage device) 1716, a signal generation device 1718 (e.g., a speaker), a network interface device 1720, and one or more sensors 1721, such as a global positioning system (GPS) sensor, compass, accelerometer, or other sensors. Machine 1700 may include an output controller 1728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, hardware processor 1702 and/or instructions 1724 may comprise processing circuitry and/or transceiver circuitry.

Storage device 1716 may include a machine-readable medium 1722 on which one or more sets of data structures or instructions 1724 (e.g., software) embodying or utilized by any one or more of the techniques or functions described herein can be stored. Instructions 1724 may also reside, completely or at least partially, within the main memory 1704, within static memory 1706, or hardware processor 1702 during execution thereof by machine 1700. In an example, one or any combination of hardware processor 1702, main memory 1704, static memory 1706, or storage device 1716 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

FIG. 17 shows the machine-readable medium 1722 as a single medium as an example. However, the term “machine-readable medium” may include a single medium or multiple media (e.g., a centralized or distributed database and/or associated caches and servers) configured to store instructions 1724.

The term “machine-readable medium” may include any medium that is capable of storing, encoding, or carrying instructions for execution by machine 1700 and that causes machine 1700 to perform any one or more of the techniques of the present disclosure or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

Instructions 1724 may further be transmitted or received over a communications network 1726 using a transmission medium via network interface device 1720 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 302.11 family of standards known as Wi-Fi®, IEEE 302.16 family of standards known as WiMax®), IEEE 302.8.4 family of standards, a Long Term Evolution (LTE) family of standards, a Universal Mobile Telecommunications System (UMTS) family of standards, peer-to-peer (P2P) networks, among others.

In an example, network interface device 1720 may include one or more physical jacks (e.g., Ethernet, coaxial, or phone jacks) or one or more antennas to connect to communications network 1726. In an example, network interface device 1720 may include a connector, in which the connector conforms with at least one of USB, High-Definition Multimedia Interface (HDMI), Thunderbolt, Peripheral Component Interconnect Express (PCIe), Ethernet, or Fiber Optic specifications. In an example, network interface device 1720 may include one or more antennas 1760 to wirelessly communicate using at least one single-input multiple-output (SIMO), multiple-input multiple-output (MIMO), or multiple-input single-output (MISO) techniques. In some examples, network interface device 1720 may wirelessly communicate using multiple-user MIMO techniques. The term “transmission medium” shall be taken to include any intangible medium that can store, encode, or carry instructions for execution by machine 1700 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, examples that include the elements shown or described are also contemplated. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of an IC chip, a system (e.g., a system in the form of machine 1700, a system on chip, a system-in-package, a system-on-package, or a combination of these systems), a set of intercommunicating functional blocks, or similar, although the scope of the disclosure is not limited in this respect.

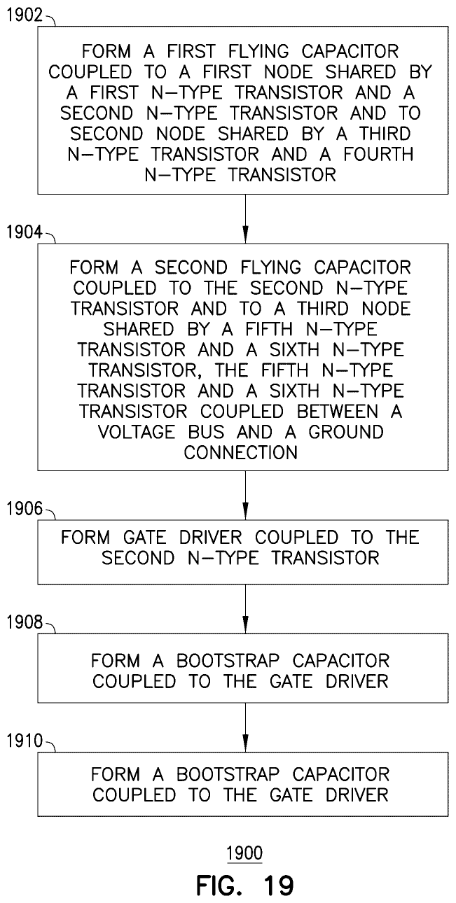

FIG. 18 is a flow diagram of a process 1800 that includes a process (e.g., a method) of making a voltage converter, according to some embodiments described herein. The voltage converter associated with process 1800 can include LEGO converter 100 or machine 1700 of FIG. 17 described above.

As shown in FIG. 18, process 1800 can include activities 1802, 1804, and 1806. Activity 1802 can include forming a first flying capacitor coupled to a first node shared by a first P-type transistor and a first N-type transistor and to a second node shared by a second P-type transistor and a second N-type transistor. Activity 1804 can include forming a second flying capacitor coupled to the first N-type transistor and to a third node shared by a third P-type transistor and a third N-type transistor, the third P-type transistor and the third N-type transistor coupled between a voltage bus and a ground connection. Activity 1806 can include forming a fourth P-type transistor and a fourth N-type transistor coupled between the voltage bus and the ground connection.

Activities 1802, 1804, and 1806 can be performed in an order different from the order shown in FIG. 18. Process 1800 can include fewer or more activities than the activities shown in FIG. 18. For example, process 1800 can include forming other elements of the apparatus including elements of LEGO converter 100 described above. Process 700 can also include activities described in the examples listed below.

FIG. 19 is a flow diagram of a process 1900 that includes a process (e.g., a method) of making a voltage converter, according to some embodiments described herein. The voltage converter associated with process 1900 can include LEGO converter 600 or 900 or machine 1700 of FIG. 17 described above.

As shown in FIG. 19, process 1900 can include activities 1902, 1904, 1906, 1908, and 1910. Activity 1902 can include forming a first flying capacitor coupled to a first node shared by a first N-type transistor and a second N-type transistor and to second node shared by a third N-type transistor and a fourth N-type transistor. Activity 1904 can include forming a second flying capacitor coupled to the second N-type transistor and to a third node shared by a fifth N-type transistor and a sixth N-type transistor, the fifth N-type transistor and a sixth N-type transistor coupled between a voltage bus and a ground connection. Activity 1906 can include forming gate driver coupled to the second N-type transistor. Activity 1908 can include forming a bootstrap capacitor coupled to the gate driver. Activity 1910 can include forming a seventh N-type transistor coupled to the bootstrap capacitor.

Activities 1902, 1904, 1906, 1908, and 1910 can be performed in an order different from the order shown in FIG. 19. Process 1900 can include fewer or more activities than the activities shown in FIG. 19. For example, process 1900 can include forming other elements of the apparatus including elements of LEGO converters 600 and 900 described above. Process 1900 can also include activities described in the examples listed below.

In the detailed description and the claims, the term “on” used with respect to two or more elements (e.g., materials), one “on” the other, means at least some contact between the elements (e.g., between the materials). The term “over” means the elements (e.g., materials) are in close proximity, but possibly with one or more additional intervening elements (e.g., materials) such that contact is possible but not required. Neither “on” nor “over” implies any directionality as used herein unless stated as such.

In the detailed description and the claims, the term “adjacent” generally refers to a position of a thing being next to (e.g., either immediately next to or close to with one or more things between them) or adjoining another thing (e.g., abutting it or contacting it (e.g., directly coupled to) it).

In the detailed description and the claims, the terms “first”, “second”, and “third,” etc. are used merely as labels, and are not intended to impose numerical requirements on their objects.

In the detailed description and the claims, a list of items joined by the term “at least one of” can mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A can include a single element or multiple elements. Item B can include a single element or multiple elements. Item C can include a single element or multiple elements.

Described implementations of the subject matter can include one or more features, alone or in combination, as illustrated below by way of examples.

Example 1 is an electronic apparatus comprising a first flying capacitor coupled to a first node shared by a first P-type transistor and a first N-type transistor and to a second node shared by a second P-type transistor and a second N-type transistor, a second flying capacitor coupled to the first N-type transistor and to a third node shared by a third P-type transistor and a third N-type transistor, the third P-type transistor and the third N-type transistor coupled between a voltage bus and a ground connection, and a fourth P-type transistor and a fourth N-type transistor coupled between the voltage bus and the ground connection.

In Example 2, the subject matter of Example 1 includes subject matter wherein the apparatus comprises a voltage converter, the voltage converter is configured to include a startup mode and a steady-state mode, and wherein the fourth P-type transistor is configured to turn on during the startup mode, and the fourth N-type transistor is configured to turn off during the startup mode.

In Example 3, the subject matter of Examples 1-2, further comprising an inductor coupled between an output node and a node shared by the fourth P-type transistor and the fourth N-type transistor.

In Example 4, the subject matter of Examples 1-3, further comprising an additional P-type transistor and an additional N-type transistor coupled between the voltage bus and the ground connection.

In Example 5, the subject matter of Examples 1-4, further comprising a fifth P-type transistor and a fifth N-type transistor coupled in series with the first P-type transistor and the first N-type transistor.

In Example 6, the subject matter of Examples 5, further comprising a first additional flying capacitor coupled to a first additional node shared by the fifth P-type transistor and the fifth N-type transistor and to a second additional node shared by a sixth P-type transistor and a sixth N-type transistor, and a second additional flying capacitor coupled to the fifth N-type transistor and to a third additional node shared by a seventh P-type transistor and a seventh N-type transistor.

In Example 7, the subject matter of Examples 1-6 includes subject matter wherein the apparatus comprises a system-on-chip (SoC), the SoC comprising the first flying capacitor, the second flying capacitor, the first through fourth P-type transistors, and the first through fourth N-type transistors

In Example 8, the subject matter of Examples 1-6, further comprising a connector and an integrated circuit (IC) chip coupled to the connector, the IC chip including the first flying capacitor, the second flying capacitor, the first through fourth P-type transistors, and the first through fourth N-type transistors, wherein the connector conforms with at least one of Universal Serial Bus (USB), High-Definition Multimedia Interface (HDMI), Thunderbolt, Peripheral Component Interconnect Express (PCIe), Ethernet, or Fiber Optic specifications.

Example 9 is an electronic apparatus comprising a first flying capacitor coupled to a first node shared by a first N-type transistor and a second N-type transistor and to second node shared by a third N-type transistor and a fourth N-type transistor, a second flying capacitor coupled to the second N-type transistor and to a third node shared by a fifth N-type transistor and a sixth N-type transistor, the fifth N-type transistor and a sixth N-type transistor coupled between a voltage bus and a ground connection, a gate driver coupled to the second N-type transistor, a bootstrap capacitor coupled to the gate driver, and a seventh N-type transistor coupled to the bootstrap capacitor.

In Example 10, the subject matter of Example 9 includes subject matter wherein the gate driver is a first gate driver, the bootstrap capacitor is a first bootstrap capacitor, and the apparatus further comprises a second gate driver coupled to the first N-type transistor, a second bootstrap capacitor coupled to the second gate driver, and an eighth N-type transistor coupled to the second bootstrap capacitor.

In Example 11, the subject matter of Example 10 includes subject matter wherein the seventh N-type transistor and the eighth N-type transistor are coupled in series with each other on a circuit path, the circuit path is coupled to a supply node.

In Example 12, the subject matter of Examples 10-11 includes subject matter wherein the apparatus comprises a voltage converter, the voltage converter is configured to include a startup mode and a steady-state mode, and wherein the first bootstrap capacitor and the second bootstrap capacitor are sequentially coupled to the supply node during the startup mode.

In Example 13, the subject matter of Example 9, further comprising an eighth N-type transistor coupled to seventh N-type transistor and the bootstrap capacitor, a first additional capacitor coupled to a node shared by the seventh N-type transistor and the eighth N-type transistor, an additional gate driver coupled to the first additional capacitor, a second additional capacitor coupled the additional gate driver, and a ninth N-type transistor coupled to the second additional capacitor.

In Example 14, the subject matter of Example 13 includes subject matter wherein the bootstrap capacitor has a size greater than a size of the first additional capacitor.

In Example 15, the subject matter of Example 13 includes subject matter wherein the bootstrap capacitor is included in a switched capacitor circuit of the apparatus, and wherein the bootstrap capacitor is configured to be charged for an amount of time less than an amount of a switching of time of the switched capacitor circuit.

In Example 16, the subject matter of Examples 9-15 includes subject matter wherein the apparatus comprises as system in a package (SiP), the SiP including the first flying capacitor, the second flying capacitor, the gate driver, the bootstrap capacitor, and the first through seventh N-type transistors.

Example 17 is an electronic apparatus comprising a switched-capacitor circuit, and a buck converter circuit coupled to the switched-capacitor circuit, the buck converter circuit including a first phase circuit including a first transistor and a second transistor coupled between a voltage bus and a ground connection, and a second phase circuit including a third transistor and a fourth transistor coupled between the voltage bus and the ground connection, wherein the first phase circuit is configured to be active in a discontinuous conduction mode of the buck converter circuit, and the second phase circuit is configured to be disabled in the discontinuous conduction mode.

In Example 18, the subject matter of Example 17, further comprising an inductor coupled between an output node and a node shared by the first transistor and the second transistor, wherein the switched-capacitor circuit includes a first flying capacitor coupled to a first node shared by a fifth transistor and a sixth transistor and to second node shared by a seventh transistor and an eighth transistor, a second flying capacitor coupled to the sixth transistor and to a third node shared by a ninth transistor and a tenth transistor, wherein the fifth transistor is configured to turn on for a first number of times in response to an output signal at the output node being outside a target range for a second number of times, and the sixth transistor is configured to turn in response to the fifth transistor is turned on.

In Example 19, the subject matter of Example 17, further comprising an additional switched-capacitor circuit including a first additional flying capacitor coupled to a first additional node shared by a first additional transistor and a second additional transistor and to second additional node shared by a third additional transistor and a fourth transistor, additional a second additional flying capacitor coupled to the second additional transistor and to a third additional node shared by a fifth additional transistor and a sixth additional transistor, the fifth additional transistor and the sixth additional transistor coupled between an additional voltage bus and the ground connection, and an additional buck converter circuit including a first additional phase circuit including a seventh additional transistor and an eighth additional transistor coupled between the additional voltage bus and the ground connection, and a second additional phase circuit including a nineth additional transistor and a tenth additional transistor coupled between the additional voltage bus and the ground connection, wherein the first additional phase circuit is configured to be active in the discontinuous conduction mode, and the second additional phase circuit is configured to be inactive in the discontinuous conduction mode.

In Example 20, the subject matter of Example 19, further comprising a first inductor coupled between an output node and a node shared by the first transistor and the second transistor, and a second inductor coupled between the output node and a node shared by the first additional transistor and the second additional transistor.

Example 21 is a method of operating a voltage converter, comprising turning on a first transistor of a buck module of the voltage converter during a startup mode of voltage converter, turning off a second transistor of the buck module during the startup mode in response to the first transistor is turned on, and exiting the startup mode and entering a steady-state mode in response to an input voltage associated with the voltage converter reaching a selected voltage.

In Example 22, the subject matter of Example 21 includes subject matter wherein the selected voltage is less than the input voltage.

In Example 23, the subject matter of Example 21 includes subject matter wherein the selected voltage is equal to the input voltage.

Example 24 is a method of operating a voltage converter, comprising entering a startup mode in a voltage converter, the voltage converter including switched capacitor modules, the switched capacitor modules including transistors coupled in series with a supply node and coupled to bootstrap capacitors, and sequentially coupling the bootstrap capacitors to a supply node during a startup mode of the voltage converter.

In Example 25, the subject matter of Example 24 includes subject matter wherein sequentially coupling the bootstrap capacitors include sequentially turning on the transistors during the startup mode.

Example 26 is a method of operating a voltage converter, comprising performing a first phase of a switched capacitor circuit of the voltage converter for a first duration, and performing a second phase of the switched capacitor circuit for a second duration, the switched capacitor circuit including a capacitor coupled in series with a bootstrap capacitor and a flying capacitor on a circuit path of the switched capacitor circuit, wherein the second duration is unequal to the first duration.

In Example 27, the subject matter of Example 26 includes subject matter wherein the second duration is less than the first duration.

In Example 28, the subject matter of Example 27 include subject matter wherein the bootstrap capacitor has a size greater than a size of the capacitor.

Example 29 is a method of operating a voltage converter, comprising activating a first phase circuit of a buck converter circuit of a voltage converter in discontinuous conduction mode of the voltage converter, and disabling a second phase circuit of the buck converter circuit in the discontinuous conduction mode, wherein the buck converter circuit is one of buck converter circuits of the voltage converter, and the buck converter circuits are coupled in parallel with each other at an output node of the voltage converter and coupled to a switch capacitor circuit.

In Example 30, the subject matter of Example 29 includes subject matter wherein activating a first phase circuit includes turning on a first transistor in the first phase circuit a first number of times in response to an output signal at the output node being outside a target range for a second number of times, and disabling the second phase circuit includes turning off a second transistor in the second phase circuit in response to the first transistor is turned on.

In Example 31, the subject matter of Example 29 includes operating the switched capacitor circuit such that the capacitor circuit changes state based on a number of an output signal at the output node falling below a target value.

Example 32 is a process of making a voltage converter, comprising forming a first flying capacitor coupled to a first node shared by a first P-type transistor and a first N-type transistor and to a second node shared by a second P-type transistor and a second N-type transistor, forming a second flying capacitor coupled to the first N-type transistor and to a third node shared by a third P-type transistor and a third N-type transistor, the third P-type transistor and the third N-type transistor coupled between a voltage bus and a ground connection, and forming a fourth P-type transistor and a fourth N-type transistor coupled between the voltage bus and the ground connection.

In Example 33, the subject matter of Example 32, further comprising forming an inductor coupled between an output node and a node shared by the fourth P-type transistor and the fourth N-type transistor.

Example 34 is a process of making a voltage converter, comprising forming a first flying capacitor coupled to a first node shared by a first N-type transistor and a second N-type transistor and to second node shared by a third N-type transistor and a fourth N-type transistor, forming a second flying capacitor coupled to the second N-type transistor and to a third node shared by a fifth N-type transistor and a sixth N-type transistor, the fifth N-type transistor and a sixth N-type transistor coupled between a voltage bus and a ground connection, forming gate driver coupled to the second N-type transistor, forming a bootstrap capacitor coupled to the gate driver, and forming a seventh N-type transistor coupled to the bootstrap capacitor.

In Example 35, the subject matter of Example 34, further comprising forming an additional gate driver coupled to the first N-type transistor, forming an additional bootstrap capacitor coupled to the additional gate driver, and forming an eighth N-type transistor coupled to the additional bootstrap capacitor.

Example 36 is an apparatus comprising at least one machine-readable medium including instructions that, when executed by processing circuitry, cause the processing circuitry to perform operations to implement any of Examples 1-31.

Example 37 is an apparatus comprising means to implement any of Examples 1-31.

Example 38 is a system to implement any of Examples 1-31.

Example 39 is a method to implement any of Examples 1-31.

In the detailed description and the claims, a list of items joined by the term “one of” can mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A can include a single element or multiple elements. Item B can include a single element or multiple elements. Item C can include a single element or multiple elements.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a first flying capacitor coupled to a first node shared by a first P-type transistor and a first N-type transistor and to a second node shared by a second P-type transistor and a second N-type transistor;
a second flying capacitor coupled to the first N-type transistor and to a third node shared by a third P-type transistor and a third N-type transistor, the third P-type transistor and the third N-type transistor coupled between a voltage bus and a ground connection; and
a fourth P-type transistor and a fourth N-type transistor coupled between the voltage bus and the ground connection.

2. The apparatus of claim 1, wherein the apparatus comprises a voltage converter, the voltage converter is configured to include a startup mode and a steady-state mode, and wherein the fourth P-type transistor is configured to turn on during the startup mode, and the fourth N-type transistor is configured to turn off during the startup mode.

3. The apparatus of claim 1, further comprising an inductor coupled between an output node and a node shared by the fourth P-type transistor and the fourth N-type transistor.

4. The apparatus of claim 1, further comprising an additional P-type transistor and an additional N-type transistor coupled between the voltage bus and the ground connection.

5. The apparatus of claim 1, further comprising a fifth P-type transistor and a fifth N-type transistor coupled in series with the first P-type transistor and the first N-type transistor.

6. The apparatus of claim 5, further comprising:
a first additional flying capacitor coupled to a first additional node shared by the fifth P-type transistor and the fifth N-type transistor and to a second additional node shared by a sixth P-type transistor and a sixth N-type transistor; and
a second additional flying capacitor coupled to the fifth N-type transistor and to a third additional node shared by a seventh P-type transistor and a seventh N-type transistor.

7. The apparatus of claim 1, wherein the apparatus comprises a system-on-chip (SoC), the SoC comprising the first flying capacitor, the second flying capacitor, the first through fourth P-type transistors, and the first through fourth N-type transistors

8. The apparatus of claim 1, further comprising a connector and an integrated circuit (IC) chip coupled to the connector, the IC chip including the first flying capacitor, the second flying capacitor, the first through fourth P-type transistors, and the first through fourth N-type transistors, wherein the connector conforms with at least one of Universal Serial Bus (USB), High-Definition Multimedia Interface (HDMI), Thunderbolt, Peripheral Component Interconnect Express (PCIe), Ethernet, or Fiber Optic specifications.

9. An apparatus comprising:
a first flying capacitor coupled to a first node shared by a first N-type transistor and a second N-type transistor and to second node shared by a third N-type transistor and a fourth N-type transistor;
a second flying capacitor coupled to the second N-type transistor and to a third node shared by a fifth N-type transistor and a sixth N-type transistor, the fifth N-type transistor and a sixth N-type transistor coupled between a voltage bus and a ground connection;
a gate driver coupled to the second N-type transistor;
a bootstrap capacitor coupled to the gate driver; and
a seventh N-type transistor coupled to the bootstrap capacitor.

10. The apparatus of claim 9, wherein the gate driver is a first gate driver, the bootstrap capacitor is a first bootstrap capacitor, and the apparatus further comprises
a second gate driver coupled to the first N-type transistor;
a second bootstrap capacitor coupled to the second gate driver; and
an eighth N-type transistor coupled to the second bootstrap capacitor.

11. The apparatus of claim 10, wherein the seventh N-type transistor and the eighth N-type transistor are coupled in series with each other on a circuit path, the circuit path is coupled to a supply node.

12. The apparatus of claim 11, wherein the apparatus comprises a voltage converter, the voltage converter is configured to include a startup mode and a steady-state mode, and wherein the first bootstrap capacitor and the second bootstrap capacitor are sequentially coupled to the supply node during the startup mode.

13. The apparatus of claim 9, further comprising:
an eighth N-type transistor coupled to seventh N-type transistor and the bootstrap capacitor;
a first additional capacitor coupled to a node shared by the seventh N-type transistor and the eighth N-type transistor;
an additional gate driver coupled to the first additional capacitor;
a second additional capacitor coupled the additional gate driver; and
a ninth N-type transistor coupled to the second additional capacitor.

14. The apparatus of claim 13, wherein the bootstrap capacitor has a size greater than a size of the first additional capacitor.

15. The apparatus of claim 13, wherein the bootstrap capacitor is included in a switched capacitor circuit of the apparatus, and wherein the bootstrap capacitor is configured to be charged for an amount of time less than an amount of a switching of time of the switched capacitor circuit.

16. The apparatus of claim 9, wherein the apparatus comprises as system in a package (SiP), the SiP including the first flying capacitor, the second flying capacitor, the gate driver, the bootstrap capacitor, and the first through seventh N-type transistors.

17. An apparatus comprising:
a switched-capacitor circuit; and
a buck converter circuit coupled to the switched-capacitor circuit, the buck converter circuit including:
a first phase circuit including a first transistor and a second transistor coupled between a voltage bus and a ground connection; and
a second phase circuit including a third transistor and a fourth transistor coupled between the voltage bus and the ground connection, wherein the first phase circuit is configured to be active in a discontinuous conduction mode of the buck converter circuit, and the second phase circuit is configured to be disabled in the discontinuous conduction mode.

18. The apparatus of claim 17, further comprising an inductor coupled between an output node and a node shared by the first transistor and the second transistor, wherein the switched-capacitor circuit includes:
a first flying capacitor coupled to a first node shared by a fifth transistor and a sixth transistor and to second node shared by a seventh transistor and an eighth transistor;
a second flying capacitor coupled to the sixth transistor and to a third node shared by a ninth transistor and a tenth transistor, wherein the fifth transistor is configured to turn on for a first number of times in response to an output signal at the output node being outside a target range for a second number of times, and the sixth transistor is configured to turn in response to the fifth transistor is turned on.

19. The apparatus of claim 17, further comprising:
an additional switched-capacitor circuit including:
a first additional flying capacitor coupled to a first additional node shared by a first additional transistor and a second additional transistor and to second additional node shared by a third additional transistor and a fourth transistor; additional
a second additional flying capacitor coupled to the second additional transistor and to a third additional node shared by a fifth additional transistor and a sixth additional transistor, the fifth additional transistor and the sixth additional transistor coupled between an additional voltage bus and the ground connection; and
an additional buck converter circuit including:
a first additional phase circuit including a seventh additional transistor and an eighth additional transistor coupled between the additional voltage bus and the ground connection; and
a second additional phase circuit including a nineth additional transistor and a tenth additional transistor coupled between the additional voltage bus and the ground connection, wherein the first additional phase circuit is configured to be active in the discontinuous conduction mode, and the second additional phase circuit is configured to be inactive in the discontinuous conduction mode.

20. The apparatus of claim 19, further comprising:
a first inductor coupled between an output node and a node shared by the first transistor and the second transistor; and
a second inductor coupled between the output node and a node shared by the first additional transistor and the second additional transistor.
